(19) United States
(12) Patent Application Publication
(10) Pub. No.: US 2008/0237257 A1
(43) Pub. Date: Oct. 2, 2008

(54) POSITIVE DISPLACEMENT MATERIAL METERING SYSTEM

(76) Inventor: Carl L. Schultz, Plymouth, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/137,451

(22) Filed: Jun. 11, 2008

Related U.S. Application Data
(62) Division of application No. 11/047,439, filed on Jan. 31, 2005, now abandoned.

(51) Int. Cl. G01F 11/00

(52) U.S. Cl. 222/1; 222/219

(57) ABSTRACT

A positive displacement material metering system is provided including a housing having an inlet port and an outlet port. A rotatable spindle is within the housing, the spindle provided with a chamber having a pair of openings. A piston is configured to reciprocate within the chamber. Each of the chamber openings is configured to receive liquid material when aligned with the inlet port and to dispense liquid material when aligned with the outlet port.

### FIELD OF THE INVENTION

The present invention relates generally to the field of metering and dispensing equipment and, more particularly, to an improved positive displacement material metering system employing fewer components while increasing the precision at which the material is metered.

### BACKGROUND OF THE INVENTION

Metering and dispensing systems are generally employed to provide a measured flow of material from a material reservoir to a particular application. For example, many operations in the manufacture of an automobile require precisely metered materials such as the application of sealants to the automobile's body structure and in the molding of the material used in seating applications. Metering and dispensing devices ensure that a specified amount of material is delivered to the application each time the material is required. Metering and dispensing devices eliminate the guess work, human error, and waste associated with having to apply a precise amount of material to an application at each required cycle.

Metering and dispensing devices are known in the art for metering and dispensing specified quantities of materials, such as sealants, adhesives, epoxies, and the like. Metering and dispensing devices are designed around the concept of a piston and cylinder. The piston is connected to a connecting rod that slides the piston fore and aft throughout the length of the cylinder much in the same way the piston works in an internal combustion engine. The connecting rod is then connected to a driveshaft that is operated by a motor. In metering and dispensing devices, when the piston reaches a specified location in the cylinder, material is allowed to fill through a cylinder inlet. When the cylinder has been filled, the piston is pushed by the connecting rod through the length of the cylinder, which in turn, forces the material out a cylinder outlet. The amount of material in the cylinder and dispersed during each cycle is a product of the cylinder height and the piston/cylinder diameter. The material can be metered either by changing the cylinder height or piston/cylinder diameter.

While the prior art does offer an adequate means for metering and dispensing materials, they are however, not optimal. First, a number of prior art metering and dispensing systems require a number of components to operate. Specifically, the piston/connecting rod/driveshaft relationship involve a number of individual components for operation (valves, cylinder, piston, connecting rod, driveshaft, and various fasteners to connect the components). Second, it is also known in the art to combine two or more metering systems together to control the flow of two or more component materials so that they may be mixed together for a particular application. However, if multiple metering and dispensing systems are required for a particular operation, a number of valves, pistons, connecting rods, and driveshafts may be required. Because a number of components are required to operate the system, this may have a significant impact on the cost to the end user. Third, with pumps employing the piston variation having depressions to control the flow of material in the cylinder, some material metering precision may be lost because there may always be some unknown amount material left in the cylinder by the depression in the piston. Finally, in order to operate a number of systems together to ensure the precise amount of material is dispensed at the correct point in time for the application, the pistons will have to be connected to by the same driveshaft. This arrangement may make for a very large piece of equipment that may consume large amounts of valuable plant floor space.

Therefore, a need exists for a positive displacement material metering system that can be utilized in compact areas and operates with fewer components while at the same time maintaining a precise delivery of material to an application on each and every required cycle. A need also exists for a material metering system that is easily expandable by simply adding cylinders or chambers and pistons as required by a particular application. The present invention satisfies these requirements.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of a metering device according to an embodiment of the present invention;

FIG. 2 is a cross-sectional view of a metering device according to an embodiment of the present invention;

FIG. 3 is a cross-sectional view of the metering device according to another embodiment of the present invention;

FIG. 4 is a cross-sectional view of the metering device according to another embodiment of the present invention;

FIGS. 5A, 5B, 5C, and 5D are cross-sectional views of the metering device shown at different positions during the cycle of operation according to an embodiment of the present invention; and

FIGS. 6A, 6B, 6C, and 6D are cross-sectional views of the metering device shown at different positions during the cycle of operation according to another embodiment of the present invention.

### DETAILED DESCRIPTION

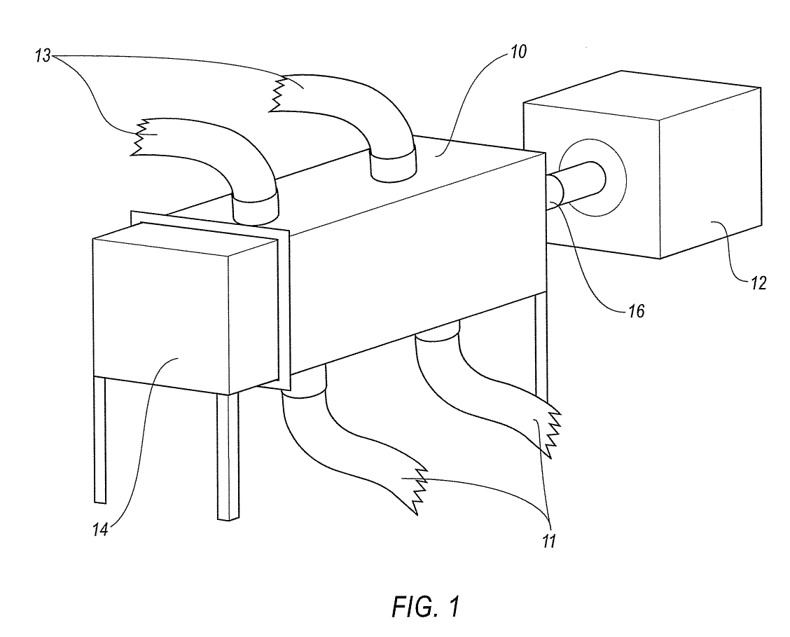

The present embodiments provide a positive displacement metering device for use in applying a measured amount of resin, epoxy, glue, grease, or the like in a manufacturing environment. Referring to FIG. 1, a positive displacement material metering device 10 is presented. In an embodiment of the present invention, metering device 10 is shown connected to a motor 12 used to operate metering device 10 in a particular environment where required such as with automobile or airplane assembly operations, medical procedures, or the oil industry. Inlet hoses 11 and outlet hoses 13 are attached to metering device 10 to allow the flow of liquid material to and from metering device 10.

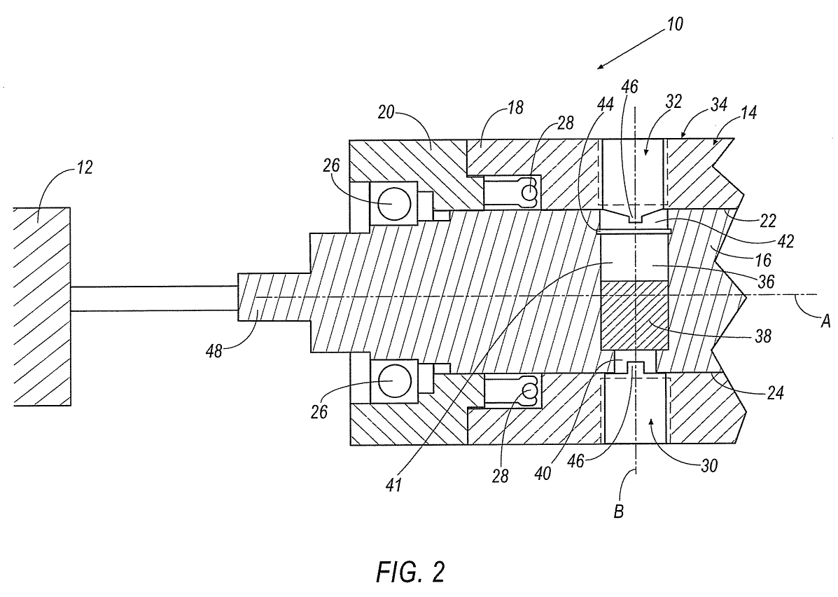

Referring now to FIG. 2, metering device 10 is illustrated. Metering device 10 includes a meter housing 14 and a spindle 16. Housing 14 includes a main portion 18 and a capturing portion 20 for securing spindle 16 within housing 14. Housing 14 further includes an interior surface 22 that provides a rotatable interface for an outer surface 24 of spindle 16 and allows spindle 16 to rotate freely within housing 14 about an axis A. Interior surface 22 covers both main and capturing portions 18 and 20 so that spindle 16 may rotate within both portions 18, 20. Interior surface 22 includes bearings 26 that spindle 16 rotates upon and are used for reducing friction between outer surface 24 and interior surface 22. Interior surface 22 further includes seals 28 that are used to ensure material does not escape housing 14 through interior surface/outer surface 24/26 interface. Bearings 26 may be manufactured from any metallic or polymeric material. Seals 28 may be manufactured from any polymeric material such as silicon.

Main portion 18 of housing 14 further includes at least one material inlet port 30 and at least one material outlet port 32. Both inlet port 30 and outlet port 32 pass from an outer surface 34 of housing 14 to interior surface 22. Both inlet port 30 and outlet port 32 are cylinders having an axis B that is generally perpendicular to axis A. Both inlet port 30 and outlet port 23 may include couplings (not shown) at outer surface 34 that allow hoses or some other means to be attached to housing 14 so that material can be supplied to metering device 10 through inlet port 30 and dispensed from metering device 10 through outlet port 32.

Spindle 16 includes a metering chamber 36 that passes completely though spindle 16 and is centered about axis B when aligned with inlet port 30 and outlet port 32. Chamber 36 is cylindrical in shape and captures a metering piston 38 that is allowed to freely rotate about axis B and freely slide throughout chamber 36 as spindle 16 is rotated about axis A. The diameter at a first end 40 of chamber 36 is smaller than the diameter of a main portion 41 of chamber 36. The smaller diameter first end 40 prevents piston 38 from passing out of chamber 36 during operation of metering device 10. The diameter of a second end 42 of chamber 36 remains the same diameter as main portion 41 of chamber 36 so that piston 38 can be easily loaded into chamber 36. Piston 38 is captured within chamber 36 at second end 42 by a locking mechanism 44 that locks and seals against the walls of chamber 36. Both first end 40 and locking mechanism 44 include holes 46 so that material can pass in and out of chamber 36. Valves are not necessary to meter the flow of material to inlet port 30 or out of outlet port 32.

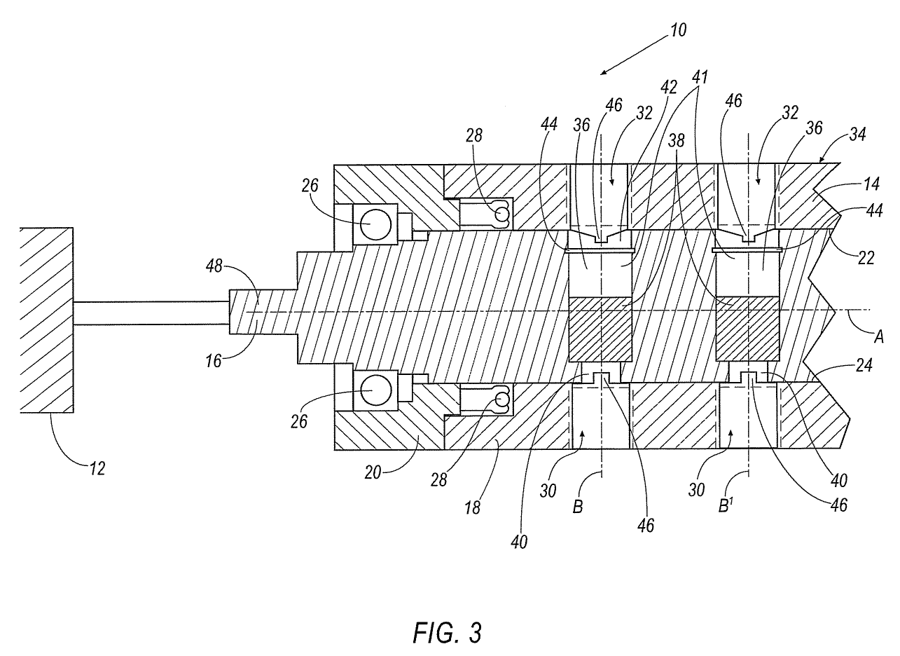

In an embodiment of the present invention shown in FIG. 2, metering device 10 is shown operating with a single metering chamber 36, metering piston 38, material inlet port 30, and material outlet port 32 arrangement. In another embodiment of the invention illustrated in FIG. 3 (where like elements have like reference numerals), the same spindle 16 may include multiple pistons 38 and chambers 36 with corresponding multiple inlet ports 30 and outlet ports 32 located on housing 14. In this way, the number of metering devices 10 can be increased on a single spindle 16, yet still only requires a single motor 12 for rotating of spindle 16. Multiple metering devices 10 allows for the inline mixing or blending of different measured materials after being dispensed from metering device 10 and prior to arriving at the particular application. A precise amount of the blended materials will be delivered to the application at each cycling of metering device 10.

Metering device 10 is assembled by inserting metering piston 38 into metering chamber 36 of spindle 16. Next, spindle 16 is inserted into main portion 18 so that material inlet port 30 and material outlet port 32 of housing 14 are aligned with chamber 36 in spindle 16. Seals 28 are added to housing 14 and, finally, capturing portion 20 and bearings 26 are secured to main portion 18 to capture spindle 16. An end 48 of spindle 16 can be connected to any conventional motor 12 so that spindle 16 can be rotated within housing 14 when metered material is required.

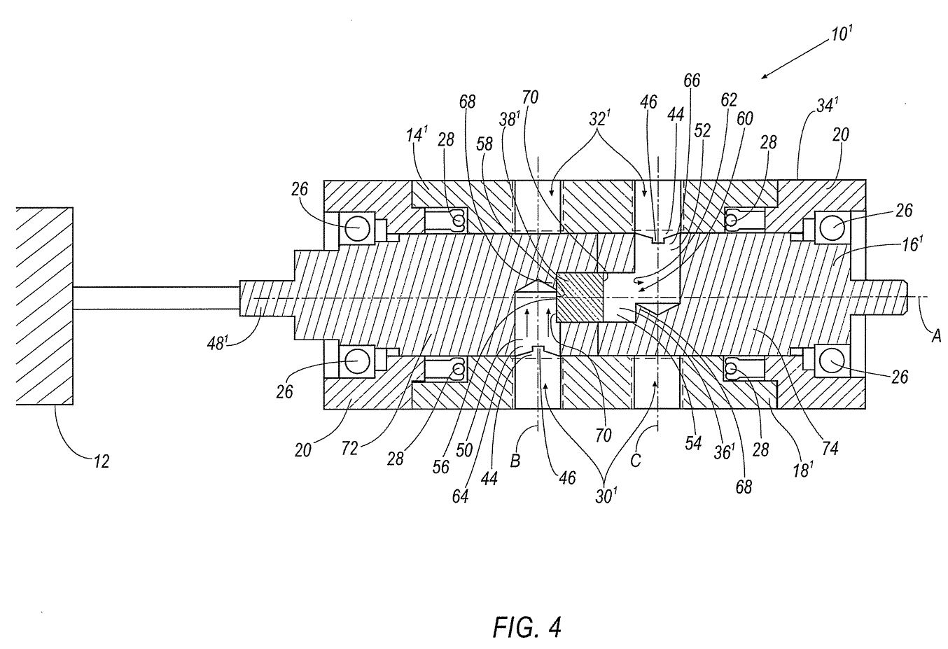

FIG. 4 illustrates another embodiment of the present invention. In this particular embodiment, metering device 10′ includes a housing 14′ and spindle 16′ similar to housing 14 and spindle 16 disclosed as part of the embodiment shown in FIG. 2. Spindle 16′ will still rotate freely about axis A within housing 14 as in the original embodiment, however, housing 14′ now includes at least two material inlet ports 30′ and at least two material outlet ports 32′. Both inlet ports 30′ and outlet ports 32′ are cylinders having axes B and C respectively that are generally parallel to each other and generally perpendicular to axis A. Both inlet ports 30′ and outlet ports 32′ may include couplings (not shown) at an outer surface 34′ of housing 14′ that allow hoses or some other means to be attached to housing 14′ so that material can be supplied to metering device 10′ through inlet ports 30′ and dispensed from metering device 10′ through outlet ports 32′.

Spindle 16′ includes a metering chamber 36′ having three segments. A first segment 50 and a third segment 52 are cylindrical in shape, centered about axis B and axis C respectively, and are generally perpendicular to axis A. A second segment 54 is also cylindrical in shape, however, second segment 54 is centered about axis A and generally perpendicular to both first and third segments 50 and 52. First segment 50 includes a first hole 56 that corresponds to a first opening 58 in second segment 54. Third segment 52 includes a second hole 60 that corresponds to a second opening 62 in second segment 54. Segments 50, 52, and 54 cooperatively form chamber 36′ and are connected such that material may flow from a first end 64 of first segment 50 through second segment 54 to a first end 66 of third segment 52 and in the reverse as well.

A metering piston 38′ is included in spindle 16′ and captured in second segment 54 of metering chamber 36′. Piston 38′ is allowed to freely slide and rotate about axis A within chamber 36′. Piston 38′, however, is prevented from fully entering first and third segments 50 and 52 by stops 68 that have been machined into chamber 36′. It is undesirable to allow piston 38′ to fully enter into first and third segments 50 and 52 because a surface 70 of piston 38′ should be presented to the material entering chamber 36′ so that material can access a sufficient portion of piston 38′ surface area to force piston 38′ to move within chamber 36′. In this particular embodiment, spindle 16′ may be a two-piece assembly so that second segment 54 of chamber 36′ can be properly machined both in a first half 72 and in a second half 74 of chamber 36′. Piston 38′ can be loaded into one half of second segment 54 prior to securing two halves 72, 74 of spindle 16′ together and creating second segment 54 of chamber 36′.

In this particular embodiment, metering device 10′ is assembled in the following manner. Piston 38′ is seated in second segment 54 of chamber 36′ in first half 72 of spindle 16′. Second half 74 of spindle 16′ is connected to first half 72 to create the entire second segment 54 and a complete spindle assembly 16′. Next spindle 16′ is inserted into main portion 18′ of housing 14′ so that material inlet ports 30′ and material outlet ports 32′ are aligned with corresponding holes 56, 60 of chamber 36′. Capturing portions 20′ are assembled to main portion 18′ to capture spindle 16′ within housing 14′. An end 48′ of spindle 16′ can be connected to any conventional motor 12 so that spindle 16′ can be rotated within housing 14′ when metered material is required.

All the embodiments described above operate in the same fashion. The difference between the embodiments relate to the number and types of materials to be metered, whether those materials can be mixed or should remain separate, and at what cycle time are the materials required to be delivered to a particular application. As will be appreciated, the following is a description of the general operation of metering device 10, keeping in mind that the same principles of operation apply to multiple metering devices 10 as well.

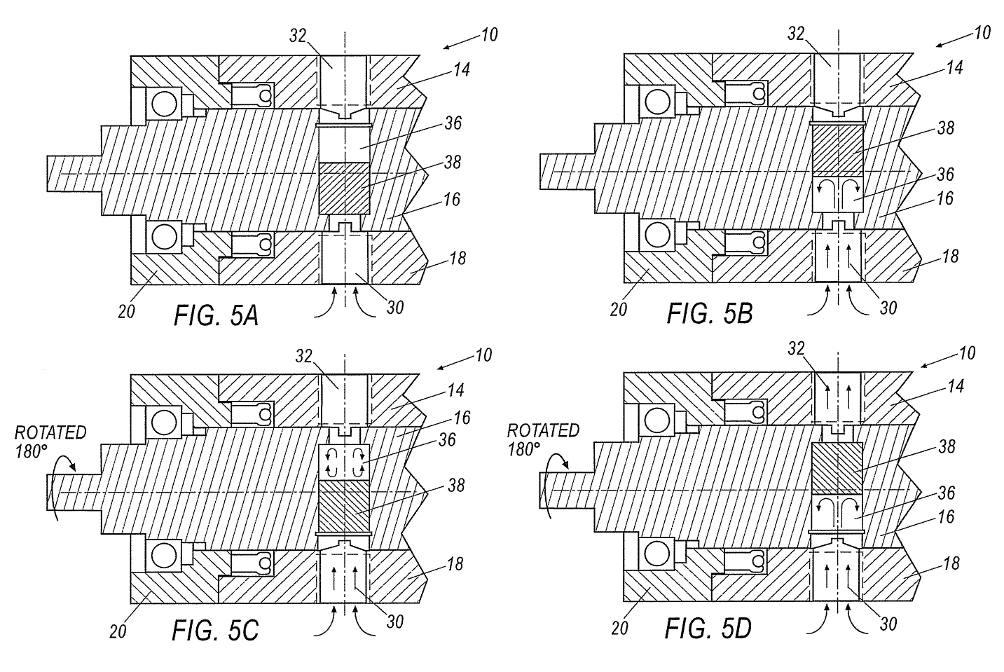

Now referring to FIGS. 5A, 5B, 5C, and 5D, operation of the embodiment illustrated in FIG. I will be described. FIG. 5A illustrated a pressurized material being presented to metering device 10 and introduced through material inlet port 30. As shown in FIG. 5B, pressurized material enters metering chamber 36 through inlet port 30 and forces metering piston 28 to opposite side of metering chamber 36. When chamber 36 is filled with material, spindle 16 may be rotated by motor 12 so that end of chamber 36 filled with material may be aligned with material outlet port 30 and opposite end with piston 38 is aligned with inlet port 30 as illustrated in FIG. 5C. As shown in FIG. 5D, more pressurized material is introduced into inlet port 30 and begins to act against piston 38, forcing piston 38 to the opposite end of chamber 36. While pressurized material is filling void left by piston 38 at inlet port 30, opposite end of piston 38 is forcing a measured amount of material out of outlet port 32 to be used in the appropriate application (See FIG. 5D). When chamber 36 is filled with pressurized material, piston 38 has completely dispensed pressurized material through outlet port 32 and spindle 16 can once again be cycled to repeat the process.

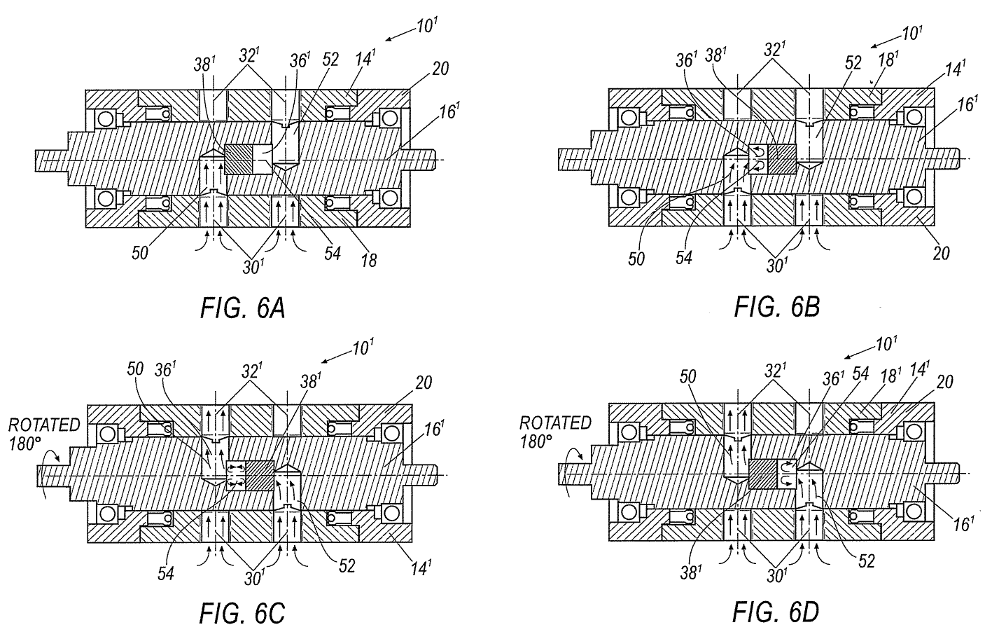

Now referring to FIGS. 6A, 6B, 6C, and 6D, operation of another embodiment of the invention illustrated in FIG. 1. will be described. In an embodiment that discloses metering chamber 10′ with multiple segments 50, 52, and 54 within spindle 16′, the same principle holds for metering and dispensing pressurized materials as was disclosed for a single segment chamber 36. In another embodiment of the present invention, two material inlets port 30′ and two material outlet ports 32 have access to the same chamber 36′. However, only one piston 38′ is required for dispensing a measured amount of material, thereby reducing the number of unique components for operation. This embodiment of the invention may be employed when two different types of material are required in an application, yet they may or may not require mixing.

FIG. 6A illustrates a pressurized material being presented to metering device 10′ and introduced through a first material inlet port 30′. As shown in FIG. 6B, pressurized material from a first source enters metering chamber 36′ through first inlet port 30′ and forces metering piston 38′ to opposite side of second segment 54 of chamber 36′. When first and second segments 50 and 54 of chamber 36′ are filled with material, spindle 16′ may be rotated by motor 12 so that end of chamber 36′ filled with material is aligned with a first material outlet port 32′ and third segment 52 is aligned with second material inlet port 30′ as illustrated in FIG. 5C. As shown in FIG. 5D, pressurized material from a second source is introduced into third segment 52 through second inlet port 30′ and begins to act against piston 38′ in second segment 54, forcing piston 38′ to the opposite end of second segment 54 of chamber 36′. While pressurized material is filling void left by piston 38′ at second inlet port 30′, opposite end of piston 38′ is forcing a measured amount of material out of first outlet port 32′ to be used in the appropriate application (See FIG. 5D). When third and second segments 52 and 54 of chamber 36′ are filled with pressurized material, piston 38′ has completely dispensed a measured amount of pressurized material through second outlet port 32′ and spindle 16′ can once again be cycled to align third segment 52 with a second outlet port 32′ and first segment 50 with first inlet port 30′ to repeat the process.

As discussed above, spindles 16, 16′ may include multiple chambers 36, 36′ for dispensing metered material and can be located at different angles relative to each other within spindle 16, 16′. The number of chambers 36, 36′ required and the angle of location relative to each other is completely dependant on the operation or application in use. Also, the amount of metered material can be varied simply by modifying the height of piston 38, 38′ and/or modifying the bore diameter of chamber 36, 36′.

Metering device 10, 10′ may be manufactured from any number and combination of materials such as metals, polymers, or ceramics. For example, housing 14, 14′, spindle 16, 16′ and piston 38, 38′ may be manufactured out of a ceramic material if the required metering of material is highly precise because ceramic components may be manufactured with tighter tolerances versus other materials. However, if durability of metering device 10, 10′ is a concern, then less brittle metallic materials such as aluminum or steel may be better suited for the particular application.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1-43. (canceled)

44. A positive displacement material metering system comprising:
a housing having an inlet port and an outlet port;
a rotatable spindle within the housing, the spindle being provided with a chamber having a pair of openings;
a piston configured to reciprocate within the chamber; and
each of the chamber openings being configured to receive liquid material when aligned with the inlet port and to dispense liquid material when aligned with the outlet port.

45. The system of claim 44 wherein the spindle is adapted to be connected to a motor for rotating the spindle within the housing.

46. The system of claim 44 wherein the piston is rotatable.

47. The system of claim 44 wherein liquid material supplied to the system is pressurized.

48. The system of claim 44 wherein the longitudinal axis of the chamber is generally parallel to the rotational axis of the spindle.

49. The system of claim 44 wherein the piston is variable in size to vary the amount of liquid material that is metered by the system.

50. The system of claim 44 wherein the chamber is variable in size to vary the amount of liquid material that is metered by the system.

51. The system of claim 44 wherein the inlet port and the outlet port are located on opposing faces of the housing.

52. The system of claim 44 wherein the inlet port and the outlet port are offset from each other.

53. The system of claim 44 wherein the pair of openings of the chamber are offset from each other.

54. A positive displacement material metering system comprising:
a housing having an inlet port and an outlet port located on opposing faces of the housing;
a rotatable spindle within the housing, the spindle being provided with a chamber having a pair of openings;
a piston configured to reciprocate within the chamber;
each of the chamber openings being configured to receive pressurized liquid material when aligned with the inlet port and to dispense liquid material when aligned with the outlet port; and
whereby an amount of liquid material dispensed by the metering device is determined by the size of the piston and of the chamber.

55. The system of claim 54 wherein the spindle is adapted to be connected to a motor for rotating the spindle within the housing.

56. The system of claim 54 wherein the longitudinal axis of the chamber is generally parallel to the rotational axis of the spindle.

57. The system of claim 54 wherein the piston is rotatable.

58. The system of claim 54 wherein the piston is variable in size to vary the amount of liquid material that is metered by the system.

59. The system of claim 54 wherein the chamber is variable in size to vary the amount of liquid material that is metered by the system.

60. The system of claim 54 wherein the inlet port and the outlet port are offset from each other.

61. The system of claim 54 wherein the pair of openings of the chamber are offset from each other.

62. A method for metering liquid material, comprising:
providing a positive displacement material metering system;
delivering a liquid material to the metering system;
displacing a piston contained in a chamber of the metering system with liquid material;
rotating a spindle contained in the metering system; and
dispensing liquid material from the metering system as the piston is displaced by delivery of liquid material.

63. The method of claim 62 wherein the metering system dispenses the same amount of liquid at each cycle.

64. The method of claim 62 wherein liquid material is pressurized as it is delivered to the metering system.

65. The method of claim 62 wherein the spindle is adapted to be connected to a motor for rotating the spindle within the housing.

66. The method of claim 62 wherein the piston is variable in size to vary the amount of liquid material delivered by the metering system.

67. The method of claim 62 wherein the chamber is variable in size to vary the amount of liquid material delivered by the metering system.

68. A positive displacement material metering system comprising:
a housing including means for receiving and dispensing liquid material;
a rotatable means contained in the housing, the rotatable means being provided with a chamber having a pair of openings; and
a reciprocating means contained within the chamber; and
each of the chamber openings being configured to receive liquid material when aligned with the receiving means and to dispense liquid material when aligned with the dispensing means.

69. The system of claim 68 wherein the rotatable means is adapted to be connected to a motor for rotating the rotatable means within the housing.

70. The system of claim 68 wherein the reciprocating means is rotatable.

71. The system of claim 68 wherein liquid material supplied to the system is pressurized.

72. The system of claim 68 wherein the longitudinal axis of the chamber is generally parallel to the rotational axis of the spindle

73. The system of claim 68 wherein the reciprocating means is variable in size to vary the amount of liquid material that is metered by the system.

74. The system of claim 68 wherein the chamber is variable in size to vary the amount of liquid material that is metered by the system.

75. The system of claim 68 wherein the receiving means and the dispensing means are located on opposing faces of said housing.

76. The system of claim 68 wherein the receiving means and the dispensing means are offset from each other.

77. The system of claim 68 wherein the pair of openings of the chamber are offset from each other.
